(19) United States
(12) Patent Application Publication
(10) Pub. No.: US 2012/0216132 A1
(43) Pub. Date: Aug. 23, 2012

(54) Embedding User Selected Content In A Web Browser Display

(75) Inventor: Michael A. Bockus, Oklahoma City, OK (US)

(73) Assignee: INTERNATIONAL BUSINESS MACHINES CORPORATION, ARMONK, NY (US)

(21) Appl. No.: 13/031,281

(22) Filed: Feb. 21, 2011

(51) Int. Cl. G06F 3/048

(52) U.S. Cl. 715/760

(57) ABSTRACT

Embedding user selected content in a web browser display, including receiving, by a web browser from a user, a selection of a display object to persistently display; and, for each of a number of subsequently accessed documents to be displayed by the web browser: retrieving, by the web browser, the document from a document source; embedding, by the web browser, the user-selected display object in the document through a document management API exposing one or more interfaces for managing documents; and displaying, by the web browser, the document with the embedded user-selected display object.

### BACKGROUND OF THE INVENTION

1. Field of the Invention

The field of the invention is data processing, or, more specifically, methods, apparatus, and products for embedding user selected content in a web browser display.

2. Description Of Related Art

Web browsers are becoming increasingly more useful to users. Moreover, resources relied upon by users are increasingly moving from locally accessible locations to remote locations accessible by web browsers. As such, users' reliance on web browsers is increasingly rapidly. At present no web browser provides a means by which a user may select an object to persistently display while navigating the Web.

### SUMMARY OF THE INVENTION

Methods, apparatus, and products for embedding user selected content in a web browser display are disclosed that include receiving, by a web browser from a user, a selection of a display object to persistently display; and for each of a plurality of subsequently accessed documents to be displayed by the web browser: retrieving, by the web browser, the document from a document source; embedding, by the web browser, the user-selected display object in the document through a document management application programming interface (‘API’) exposing one or more interfaces for managing documents; and displaying, by the web browser, the document with the embedded user-selected display object.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system for embedding user selected content in a web browser display according to embodiments of the present invention.

FIG. 2 sets forth a line drawing of an exemplary GUI presented by a web browser displaying a document with a user-selected display object embedded in the document in accordance with embodiments of the present invention.

FIG. 3 sets forth a line drawing of a further exemplary GUI presented by the web browser displaying a subsequently accessed document with the user-selected display object embedded in the subsequently accessed document in accordance with embodiments of the present invention.

FIG. 4 sets forth a flow chart illustrating an exemplary method for embedding user selected content in a web browser display according to embodiments of the present invention.

FIG. 5 sets forth a flow chart illustrating a further exemplary method for embedding user selected content in a web browser display according to embodiments of the present invention.

FIG. 6 sets forth a flow chart illustrating a further exemplary method for embedding user selected content in a web browser display according to embodiments of the present invention.

FIG. 7 sets forth a flow chart illustrating a further exemplary method for embedding user selected content in a web browser display according to embodiments of the present invention.

### DETAILED DESCRIPTION OF EXEMPLARY EMBODIMENTS

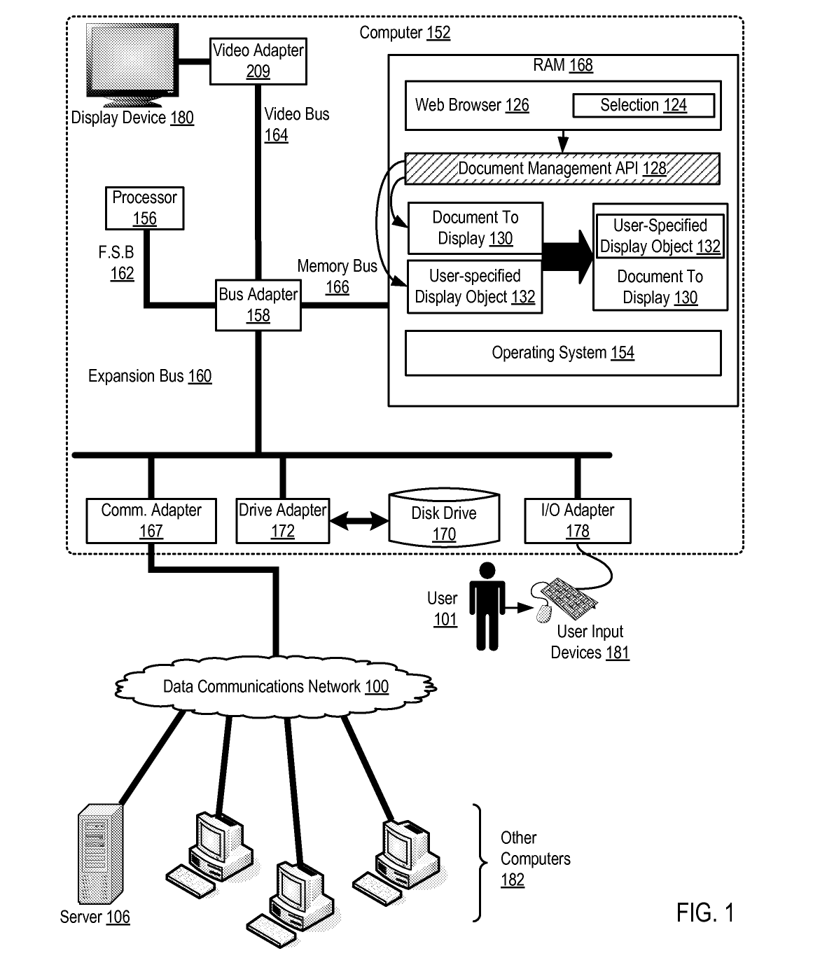

Exemplary methods, apparatus, and products for embedding user selected content in a web browser display in accordance with the present invention are described with reference to the accompanying drawings, beginning with FIG. 1. FIG. 1 sets forth a block diagram of an example system for embedding user selected content in a web browser display according to embodiments of the present invention. The system of FIG. 1 includes automated computing machinery comprising an exemplary computer (152) useful in embedding user selected content in a web browser display according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a web browser (126), a module of automated computing machinery which may be implemented as computer software, computer hardware, or an aggregation of computer hardware and software. A web browser generally comprises a software application that retrieves, presents, and traverses information resources on the World Wide Web, local file systems, or other storage locations. An information resource may be specified by a Uniform Resource Identifier (‘URI’) or Uniform Resource Locator (‘URL’) and may be a web page, image, video, or other piece of content. Information resources, such as web pages, are typically implemented as documents such as Hypertext Markup Language (‘HTML’) documents, eXtensible Markup Language (‘XML’) documents, and so on. Hyperlinks present in resources enable users to easily navigate the web browser to related resources. Although browsers are primarily intended to access the World Wide Web, browsers may also access information provided by Web servers in private networks or files in file systems.

The example web browser (126) in FIG. 1 has been improved to support embedding user selected content in a web browser display according to embodiments of the present invention. The web browser (126) operates for embedding user selected content in a web browser display according to embodiments of the present invention by receiving, from a user (101), a selection (124) of a display object (132) to persistently display; and for each of a plurality of subsequently accessed documents to be displayed by the web browser: retrieving the document (130) from a document source; embedding the user-selected display object (132) in the document through a document management application programming interface (‘API’) (128) exposing one or more interfaces for managing documents; and displaying the document (130) with the embedded user-selected display object (132).

A display object (132) as the term is used in this specification refers to any content which may be embedded in a document for display by a web browser. Examples of such display objects include digital images, text, tables, interactive modules of computer program instructions, and so on as will occur to readers of skill in the art. Documents to be displayed by a web browser—referred to from time to time in this specification as web documents—include any information resource that may be parsed and rendered for display by a web browser's rendering and layout engine. Examples of such web documents web pages formed of HTML documents, XML documents, XHTML documents, and so on as will occur to readers of skill in the art. Documents may be stored on any document source—a location at which a web document may be retrieved. In the example of FIG. 1, any of the other computers (182), including the server (106), may be a document source. In addition, the computer (152) itself upon which the web browser (126) executes may be a document source.

In the example of FIG. 1, the web browser (126) the display object (132) is said to be selected by a user (101) to be ‘persistently’ displayed. A display object (132) is persistently displayed in that the object is displayed even after a user navigates to a subsequent other web documents. From the perspective of a user, for example, the display object, once embedded in a web page, is displayed thereafter when subsequently accessed web pages are displayed.

A document management API provides a means for interacting with elements of a web document. Such a document management API may specify methods for adding, creating, and modifying elements of a document to be displayed by a web browser. A document object model (‘DOM’) is an example of a document management API that specifies various interfaces for management—addressing, modification, creation, and so on—of elements of a document. DOMs are employed by web browsers and represent a web document as a tree of child and parent nodes. That is, each element of a web document is separate node in a tree of nodes. The DOM specifies commands and syntax for interacting with the elements of the web documents by addressing the elements as nodes. In this way, DOMs provide a platform-independent means for modeling and interacting with web documents.

Also stored in RAM (168) is an operating system (154). Operating systems useful in computers that support embedding user selected content in a web browser display according to embodiments of the present invention include UNIX™, Linux™, Microsoft XP™, AIX™, IBM's i5/OS™, and others as will occur to those of skill in the art. The operating system (154), web browser (126), document management API (128), and so on in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for embedding user selected content in a web browser display according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for embedding user selected content in a web browser display according to embodiments of the present invention include modems for wired dial-up communications, Ethernet (IEEE 802.3) adapters for wired data communications network communications, and 802.11 adapters for wireless data communications network communications.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

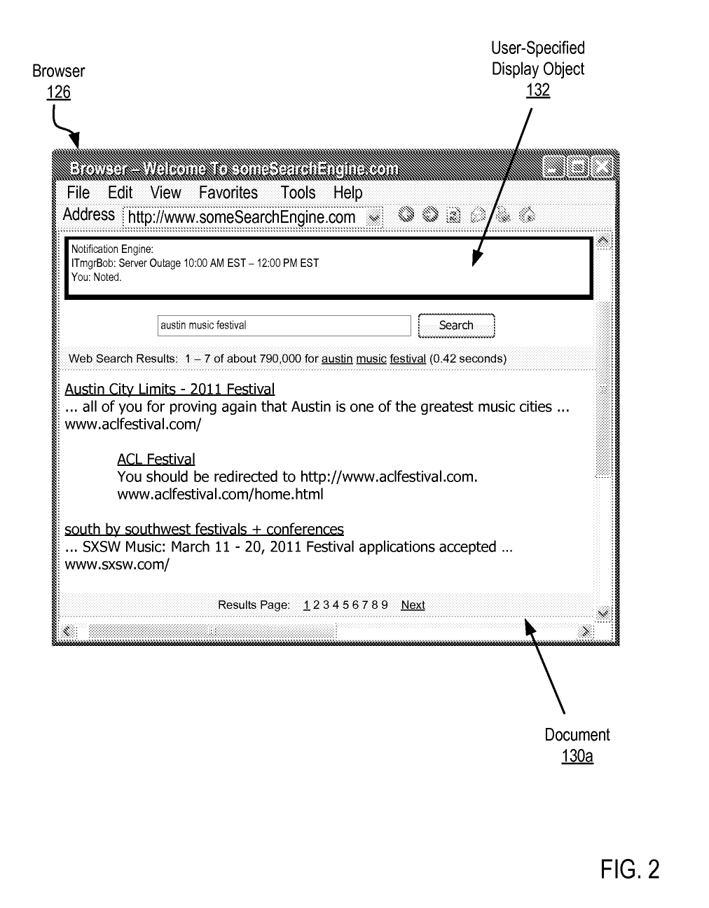

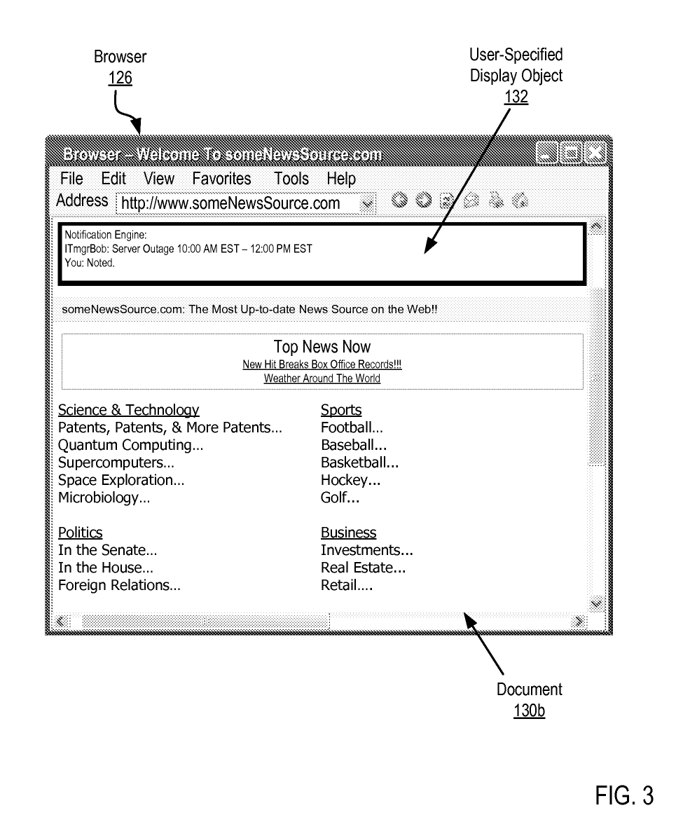

As mentioned above, the example web browser (126) of FIG. 1 is configured to embed a user-selected display object persistently, for each of a plurality of subsequently accessed documents. For further explanation, therefore, FIGS. 2 and 3 set forth line drawings of an exemplary graphical user interface (‘GUI’) presented by a web browser displaying subsequently accessed documents with a user-selected display object embedded in the documents in accordance with embodiments of the present invention. That is, FIG. 2 depicts a display by a web browser of a first accessed web document with an embedded display object and FIG. 3 sets forth a display by the same web browser of a second web document—a web document accessed subsequent to the first web document of FIG. 2—each of which includes the same embedded display object. As the GUI of FIG. 2 and FIG. 3 represent the web browser, the GUI will be referred to as the web browser (126) for ease of explanation. That is, in the descriptions of FIGS. 2 and 3 below, the term ‘web browser’ may be used synonymously with the GUI presented by the web browser.

The web browser (126) in the example of FIG. 2 has been navigated to a web page—http://www.someSearchEngine.com—that operates as web search engine. A user interacting with the web browser (126) has selected a display object (132) to embed with the someSearchEngine web document (130a) and other subsequently accessed web documents. The user-selected display object (132) in the example of FIG. 2 includes a notification engine in which the user interacting with the web browser (126) may send text-based messages to another user that can reply with text-based messages. Such a notification engine may, for example, be implemented as a software script executing locally or on a remote web server. That is, a user-selected display object need not be limited to static objects such as digital images or text, but may also include interactive objects. In the example of FIG. 2, the web browser (126) as part of embedding the user-specified display object (132) has also modified the originally retrieved web document for the search engine web page, moving elements down the page. That is, the user-specified display object has been embedded into the web page in such a way as to be located at the top of the web page, when the web page is displayed, while all other portions of the web page are rearranged to support the newly embedded object at that location.

Moving to FIG. 3, the user of the web browser (126) has navigated away from the search engine web page of FIG. 2 to another web page—http://www.someNewsSource.com—that provides news. That is, the news web page depicted in the example of FIG. 3 is a web page subsequently accessed to the search engine web page of FIG. 2. Embedded in the web document (130b) of FIG. 3 is the same user-selected display object (132) embedded in the web document (130a) of FIG. 2. In this way, the user-selected display object (132) may be persistently displayed over subsequently accessed web documents.

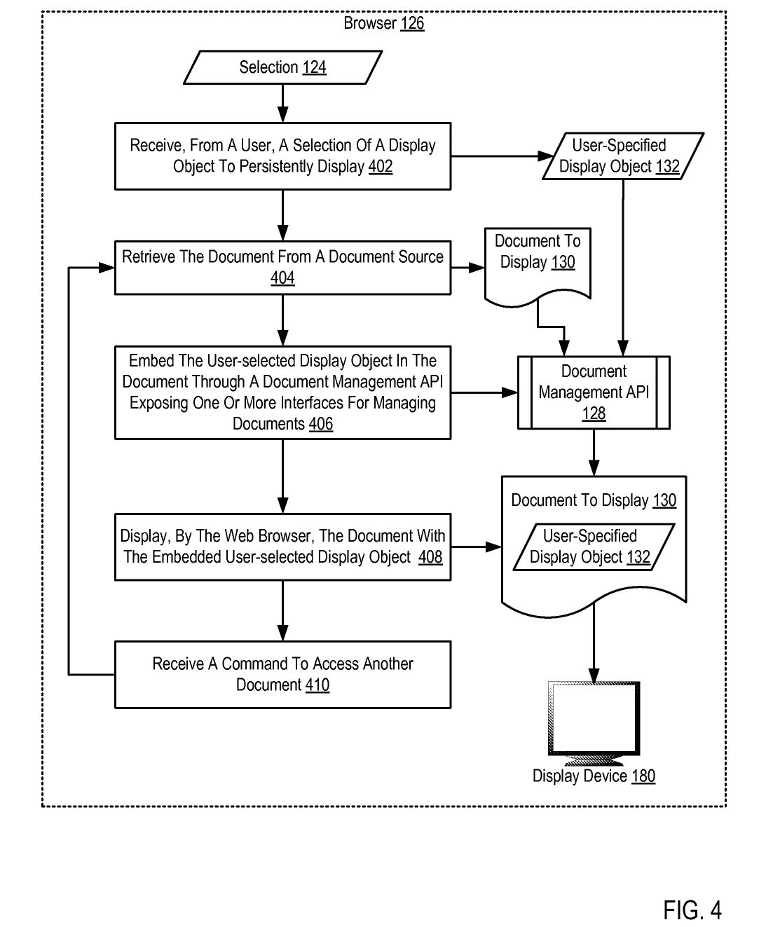

For further explanation, FIG. 4 sets forth a flow chart illustrating an exemplary method for embedding user selected content in a web browser display according to embodiments of the present invention. The method of FIG. 4 includes receiving (402), by a web browser (126) from a user, a selection (124) of a display object (132) to persistently display.

Receiving (402) a user selection (124) of a display object (132) to persistently display may be carried out in various ways including, for example, by receiving the user selection (124) through interaction with one or more GUI objects of a GUI presented by the web browser. The web browser (126), for example, may present to a user a GUI similar to those depicted in the examples of FIG. 2 and FIG. 3. In such an example GUI, the web browser may present GUI objects—buttons, file menu options, drop down selection lists, and the like—that enable a user to provide a selection of a display object (132). One example of a GUI object that enables a user to provide a selection of a display object (132) may be a file menu that, once selected by the user via a mouse, keyboard, or other user interface device, sets forth a user-selectable option to specify a display object for persistent display. Once the option is selected, the user may then specify a storage location of the display object. Additionally, a user may also specify a location at which the display object is to be embedded within a web browser display—top left corner, top banner, bottom banner, top right corner, left side banner, right side banner, and the like.

The remaining steps set forth in the method of FIG. 4 are carried out for each of a plurality of subsequently accessed documents to be displayed by the web browser. In this fashion, the method of FIG. 4 includes retrieving (404), by the web browser (126), the document (130) from a document source. Retrieving (404) the document from a document source may be carried out in various ways including, for example, through HTTP GET request messages for documents specified by a URL or URI that includes an HTTP protocol.

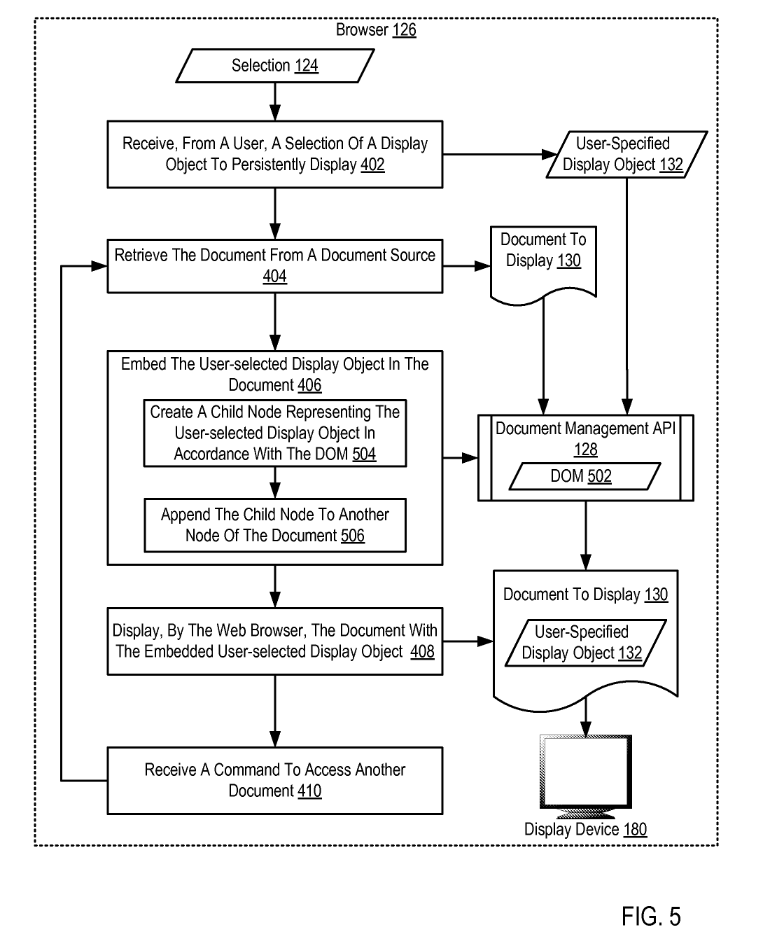

The method of FIG. 4 also includes embedding (406), by the web browser (126), the user-selected display object (132) in the document (130) through a document management application programming interface (API) (128) exposing one or more interfaces for managing documents. Embedding the user-selected display object is described below in detail with regard to FIG. 5.

The method of FIG. 4 also includes displaying (408), by the web browser (126), the document (130) with the embedded user-selected display object (132). Displaying (408) the document (130) with the embedded user-selected display object (132) is carried out in the same manner as displaying any web document—parsing the document and displaying the document's elements in accordance with the attributes, content, and protocols specifying the element's display characteristics. That is, from the perspective of the web browser (or the web browser's document parsing, layout, and rendering engines) the document (130) with the embedded display object (132) is a document like any other and is displayed in exactly the same manner.

The method of FIG. 4 continues by receiving (410) a command, from a user, to access another document (130). The web browser (126) then retrieves (404) the subsequently accessed document, embeds (406) the user-selected display object (132), and displays (408) the document (130) with the embedded user-selected display object (132). In this way, the user-selected display object is persistently displayed by the web browser over subsequent accesses of different documents.

For further explanation, FIG. 5 sets forth a flow chart illustrating a further exemplary method for embedding user selected content in a web browser display according to embodiments of the present invention. The method of FIG. 5 is similar to the method of FIG. 4 in that the method of FIG. 5 includes receiving (402) a selection (124) of a display object (132) to persistently display and, for each of a plurality of subsequently accessed documents: retrieving (404) the document (130) from a document source, embedding (406) the user-selected display object (132), and displaying (408) the document (130) with the embedded user-selected display object (132).

The method of FIG. 5 differs from the method of FIG. 4, however, in that in the method of FIG. 5, the document management API (128) is implemented as a DOM (502). The DOM in the example of FIG. 5 represents, or said another way ‘models,’ the document (130) as a hierarchy of nodes and specifies interaction with the elements of the document (130) by addressing the elements as nodes. As such, in the method of FIG. 5, embedding (406) the user-selected display object (132) in the document (130) is carried out by creating (504) a child node representing the user-selected display object in accordance with the DOM (502) and appending (506) the child node to another node of the document.

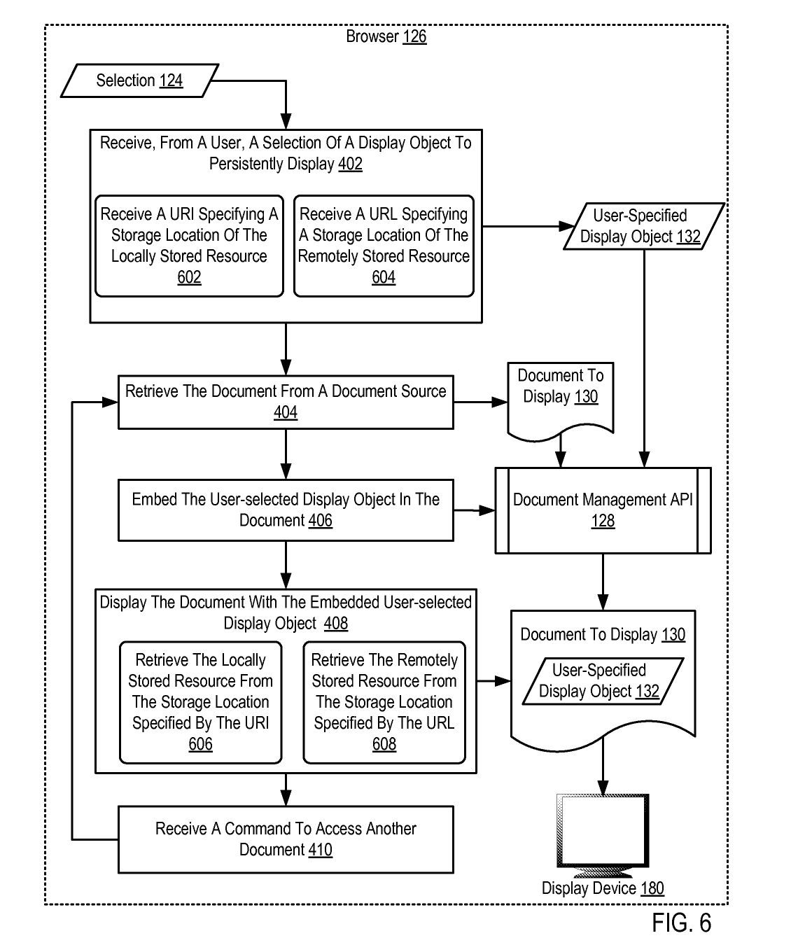

For further explanation, FIG. 6 sets forth a flow chart illustrating a further exemplary method for embedding user selected content in a web browser display according to embodiments of the present invention. The method of FIG. 6 is similar to the method of FIG. 4 in that the method of FIG. 6 includes receiving (402) a selection (124) of a display object (132) to persistently display and, for each of a plurality of subsequently accessed documents: retrieving (404) the document (130) from a document source, embedding (406) the user-selected display object (132), and displaying (408) the document (130) with the embedded user-selected display object (132).

The method of FIG. 6 differs from the method of FIG. 5, however, in that in the method of FIG. 6 the user-selected display object (132) may be implemented as a locally stored resource or a remotely stored resource. A locally stored resource is a resource addressable (accessible) by a file path. A remotely stored resource is a resource addressable by other means.

In the method of FIG. 6, when the user-specified display object is a locally stored resource, receiving (402) the selection (124) of the display object to persistently display is carried out by receiving (602) a URI specifying a storage location of the locally stored resource. When the user-specified display object is a remotely stored resource, receiving (402) the selection (124) of the display object to persistently display is carried out by receiving (604) a URL specifying a storage location of the remotely stored resource.

In the method of FIG. 6, when the user-specified display object is a locally stored resource, displaying (408) the document with the embedded user-selected display object is carried out by retrieving (606) the locally stored resource from the storage location specified by the URI. And when the user-specified display object (132) is a remotely stored resource, displaying (408) the document with the embedded user-selected display object is carried out by retrieving (608) the remotely stored resource from the storage location specified by the URL.

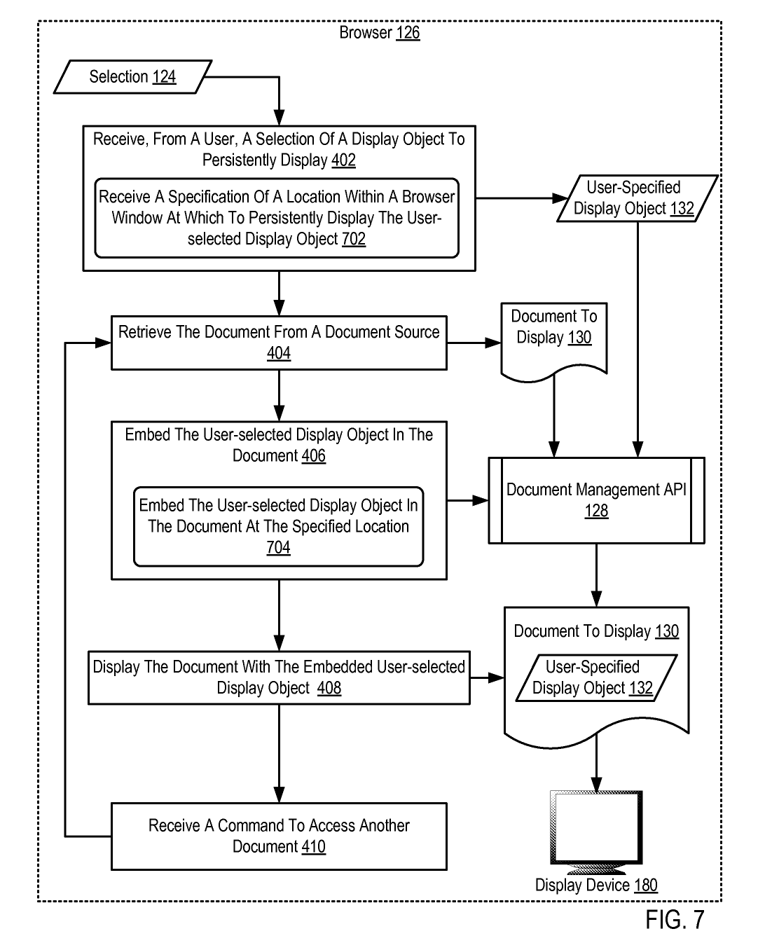

For further explanation, FIG. 7 sets forth a flow chart illustrating a further exemplary method for embedding user selected content in a web browser display according to embodiments of the present invention. The method of FIG. 7 is similar to the method of FIG. 4 in that the method of FIG. 7 includes receiving (402) a selection (124) of a display object (132) to persistently display and, for each of a plurality of subsequently accessed documents: retrieving (404) the document (130) from a document source, embedding (406) the user-selected display object (132), and displaying (408) the document (130) with the embedded user-selected display object (132).

The method of FIG. 7 differs from the method of FIG. 5, however, in that in the method of FIG. 7, receiving (402) the selection (124) of the display object to persistently display includes receiving (702) a specification of a location within a browser window at which to persistently display the user-selected display object. Receiving (702) a specification of a location within a browser window at which to persistently display the user-selected display object may be carried out in various ways including, receiving a user's mouse click (right-click for example) on the location within the window, and receiving an instruction to embed a user-selected display object at the location. Alternatively, the web browser may provide a user a predefined set of optional locations at which to embed an object and the user may select one of the predefined locations.

In the method of FIG. 7, embedding (406) the user-selected display object (132) in the document includes embedding (704) the user-selected display object in the document at the specified location. Embedding (704) the user-selected display object (132) at the specified location may include modifying attributes of other elements in the original, unmodified document. Consider, for example, that an original, unmodified document specifies a table for display at the top of a web browser window and the user specifies a top-banner location at which to display the user-selected display object. One example way in which the web browser may embed the user-selected display object at the top-banner includes modifying the original attributes of the table to position the table at a location lower than the newly embedded user-selected display object. Readers of skill in the art will recognize that this is but one way, among many, that a web browser may embed a user-selected display object at a user-specified location. Other ways are possible and each such way is well within the scope of the present application.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable transmission medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable transmission medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable transmission medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of embedding user selected content in a web browser display, the method comprising:
receiving, by a web browser from a user, a selection of a display object to persistently display; and
for each of a plurality of subsequently accessed documents to be displayed by the web browser:
retrieving, by the web browser, the document from a document source;
embedding, by the web browser, the user-selected display object in the document through a document management application programming interface (‘API’) exposing one or more interfaces for managing documents; and
displaying, by the web browser, the document with the embedded user-selected display object.

2. The method of claim 1 wherein:
wherein the document management API comprises a document object model (‘DOM’), the DOM representing the document as a hierarchy of nodes; and
embedding the user-selected display object in the document further comprises creating a child node representing the user-selected display object in accordance with the DOM and appending the child node to another node of the document.

3. The method of claim 1 wherein:
the user-selected display object further comprises a locally stored resource;
receiving the selection of the display object to persistently display further comprises receiving a Uniform Resource Identifier (‘URI’) specifying a storage location of the locally stored resource; and
displaying the document with the embedded user-selected display object further comprises retrieving the locally stored resource from the storage location specified by the URI.

4. The method of claim 1 wherein:
the user-selected display object further comprises a remotely stored resource;
receiving the selection of the display object to persistently display further comprises receiving a Uniform Resource Locator (‘URL’) specifying a storage location of the remotely stored resource; and
displaying the document with the embedded user-selected display object further comprises retrieving the remotely stored resource from the storage location specified by the URL.

5. The method of claim 1 wherein:
receiving the selection of the display object to persistently display further comprises receiving a specification of a location within a browser window at which to persistently display the user-selected display object; and
embedding the user-selected display object in the document further comprises embedding the user-selected display object in the document at the specified location.

6. The method of claim 1 wherein:
receiving the selection of the display object to persistently display further comprises receiving the selection in response to the user's interaction with one on or more Graphical User Interface (‘GUI’) objects presented by the web browser.

7. Apparatus for embedding user selected content in a web browser display, the apparatus comprising a computer processor, a computer memory operatively coupled to the computer processor, the computer memory having disposed within it computer program instructions that, when executed by the computer processor, cause the apparatus to carry out the steps of:
receiving, by a web browser from a user, a selection of a display object to persistently display; and
for each of a plurality of subsequently accessed documents to be displayed by the web browser:
retrieving, by the web browser, the document from a document source;
embedding, by the web browser, the user-selected display object in the document through a document management application programming interface (‘API’) exposing one or more interfaces for managing documents; and
displaying, by the web browser, the document with the embedded user-selected display object.

8. The apparatus of claim 7 wherein:
wherein the document management API comprises a document object model (‘DOM’), the DOM representing the document as a hierarchy of nodes; and
embedding the user-selected display object in the document further comprises creating a child node representing the user-selected display object in accordance with the DOM and appending the child node to another node of the document.

9. The apparatus of claim 7 wherein:
the user-selected display object further comprises a locally stored resource;
receiving the selection of the display object to persistently display further comprises receiving a Uniform Resource Identifier (‘URI’) specifying a storage location of the locally stored resource; and
displaying the document with the embedded user-selected display object further comprises retrieving the locally stored resource from the storage location specified by the URI.

10. The apparatus of claim 7 wherein:
the user-selected display object further comprises a remotely stored resource;
receiving the selection of the display object to persistently display further comprises receiving a Uniform Resource Locator (‘URL’) specifying a storage location of the remotely stored resource; and
displaying the document with the embedded user-selected display object further comprises retrieving the remotely stored resource from the storage location specified by the URL.

11. The apparatus of claim 7 wherein:
receiving the selection of the display object to persistently display further comprises receiving a specification of a location within a browser window at which to persistently display the user-selected display object; and
embedding the user-selected display object in the document further comprises embedding the user-selected display object in the document at the specified location.

12. The apparatus of claim 7 wherein:
receiving the selection of the display object to persistently display further comprises receiving the selection in response to the user's interaction with one on or more Graphical User Interface (‘GUI’) objects presented by the web browser.

13. A computer program product for embedding user selected content in a web browser display, the computer program product disposed upon a computer readable storage medium, the computer program product comprising computer program instructions capable, when executed, of causing a computer to carry out the steps of:
receiving, by a web browser from a user, a selection of a display object to persistently display; and
for each of a plurality of subsequently accessed documents to be displayed by the web browser:
retrieving, by the web browser, the document from a document source;
embedding, by the web browser, the user-selected display object in the document through a document management application programming interface (‘API’) exposing one or more interfaces for managing documents; and
displaying, by the web browser, the document with the embedded user-selected display object.

14. The computer program product of claim 13 wherein:
wherein the document management API comprises a document object model (‘DOM’), the DOM representing the document as a hierarchy of nodes; and
embedding the user-selected display object in the document further comprises creating a child node representing the user-selected display object in accordance with the DOM and appending the child node to another node of the document.

15. The computer program product of claim 13 wherein:
the user-selected display object further comprises a locally stored resource;
receiving the selection of the display object to persistently display further comprises receiving a Uniform Resource Identifier (‘URI’) specifying a storage location of the locally stored resource; and
displaying the document with the embedded user-selected display object further comprises retrieving the locally stored resource from the storage location specified by the URI.

16. The computer program product of claim 13 wherein:
the user-selected display object further comprises a remotely stored resource;
receiving the selection of the display object to persistently display further comprises receiving a Uniform Resource Locator (‘URL’) specifying a storage location of the remotely stored resource; and
displaying the document with the embedded user-selected display object further comprises retrieving the remotely stored resource from the storage location specified by the URL.

17. The computer program product of claim 13 wherein:
receiving the selection of the display object to persistently display further comprises receiving a specification of a location within a browser window at which to persistently display the user-selected display object; and
embedding the user-selected display object in the document further comprises embedding the user-selected display object in the document at the specified location.

18. The computer program product of claim 13 wherein:
receiving the selection of the display object to persistently display further comprises receiving the selection in response to the user's interaction with one on or more Graphical User Interface (‘GUI’) objects presented by the web browser.

19. The computer program product of claim 13 wherein the computer readable medium comprises a storage medium.

20. The computer program product of claim 13 wherein the computer readable medium comprises a transmission medium.
